(19) United States
(12) Patent Application Publication
(10) Pub. No.: US 2019/0312269 A1
(43) Pub. Date: Oct. 10, 2019

(54) STABLE LOW VOLTAGE ELECTROCHEMICAL CELL

(71) Applicant: CAMX POWER, LLC., Lexington, MA (US)

(72) Inventors: Jack Treger, Quincy, MA (US); David Ofer, Needham, MA (US); Suresh Sriramulu, Arlington, MA (US)

(21) Appl. No.: 16/461,053

(22) PCT Filed: Nov. 22, 2017
(86) PCT No.: PCT/US2017/062972

§ 371 Date: May 15, 2019

Related U.S. Application Data
(60) Provisional application No. 62/425,270, filed on Nov. 22, 2016.
(60) Provisional application No. 62/441,830, filed on Jan. 3, 2017.
(60) Provisional application No. 62/472,820, filed on Mar. 17, 2017.

(51) Int. Cl. H01M 4/38; H01M 4/62; H01M 4/66; H01M 6/16; H01M 6/18; H01M 2/16; H01M 4/06

(52) U.S. Cl. CPC H01M 4/382; H01M 4/387; H01M 4/622; H01M 4/661; H01M 6/164; H01M 6/166; H01M 2300/0025; H01M 2/1653; H01M 2/1613; H01M 4/06; H01M 2220/30; H01M 2300/0082; H01M 6/181

(57) ABSTRACT

Provided are primary electrochemical cells having a stable operating voltage of 0.3 V to 2.0 V that include a Li anode coupled to a cathode that is formed of one or more Group 4A, 3A, or 5A elements provided alone or as an alloy with a second, third or other Group 4A, 3A, or 5A element or one or more transition metals. The cells further include a non-aqueous electrolyte optionally with low volatility such as having a vapor pressure of 5 mm Hg or lower at STP, and optionally a lithium-ion conductive and electrically insulating separator inserted between the anode and the cathode. The cells provide stable operating voltage that in some aspects can serve to power ultra-low power devices for 10 or more years without the need for expensive or inefficient circuitry to alter the cell voltage.

### CROSS REFERENCE TO RELATED APPLICATIONS

This application depends from and claims priority to U.S. Provisional Application No. 62/425,270 filed Nov. 22, 2016, and to U.S. Provisional Application No. 62/441,830 filed Jan. 3, 2017, and to U.S. Provisional Application No. 62/472,820 filed Mar. 13, 2017, the entire contents of each of which are incorporated herein by reference.

### FIELD

This invention relates to electrochemical cells suitable for use in devices or electrical systems requiring a stable low voltage and high capacity primary battery such as ultra-low power subthreshold electronic circuits in remote wireless sensors or communication devices.

### BACKGROUND

Ultra-low power electronic circuits, consuming as little as 10 nW and assembled from devices operating below conventional threshold voltages (for example, transistors gated at voltage below normal “on” voltage), can enable very long life for unattended sensors and sensor radio networks, and for consumer, business and commercial products that are wirelessly networked, because they require very little energy. Such subthreshold circuits typically operate at voltages well below 1.0 V. When typical batteries are used to power these subthreshold circuits, the voltage must be electronically stepped down in an inefficient process that negates the ultra-low power consumption of the circuits themselves. Therefore, lower voltage batteries are needed to power such subthreshold circuits with maximum efficiency and minimum power consumption.

Electrochemical couples for these low voltage batteries will typically be required to have voltage less than 2.0 V and more typically less than 1.0 V, and more specifically less than or equal to about 0.7 V, while also providing high capacity (e.g., 100 mAh) for discharge at currents up to 1 μA in small cells of 0.5 cc or lower volume. It is highly desirable that such low-voltage batteries maintain near-constant voltage under their full range of operating conditions. However, presently available batteries have an equilibrium discharge voltage that unacceptably decreases as the capacity of the cell is consumed.

Some electrochemical cells with flat, stable discharge profile are known, such as shown in Table 1, but all except Cd/HgO have a voltage that is unsuitably high for use in ultra-low power subthreshold electronic circuits. These high voltages can be lowered to a useful range using electronic circuitry such as linear voltage controllers or switched power circuits; however, the penalty is low conversion efficiency, added bulk or added cost. While Cd/HgO may have a suitable voltage (under 1.0 V), the capacity is relatively low and the materials used are highly toxic.

TABLE 1
Illustrative electrochemical couples with relatively flat discharge
profile that are unsuitable for ultra-low power applications.

| Electrochemical | Voltage | Energy | |
|---|---|---|---|
| Couple | volts | Density Wh/L | Comments |
| Li/SO₂ | 2.9 | 415 | Voltage too high |
| Li/I₂ | 2.8 | 900 | Voltage too high |
| Li/CFₓ | 2.6 | 650 | Voltage too high |
| Zn/Ag₂O | 1.55 | 500 | Voltage too high |
| Li/CuO | 1.5 | 570 | Voltage too high |
| Zn/HgO | 1.3 | 470 | Voltage too high, |
| | | | toxic |
| Ni/MH | 1.25 | 250 | Voltage too high, |
| | | | low capacity |
| Zn/Air | 1.2 | 1000 | Voltage too high, |
| | | | short activated life |
| Cd/HgO | 0.9 | 230 | Toxic, low capacity |

As such there is a need for a new electrochemical cell capable of providing a stable voltage less than 2.0 V and more typically less than 1.0 V, while also providing high capacity for discharge at currents up to 1 μA in small cells of 0.5 cc or lower volume.

### SUMMARY

The following summary is provided to facilitate an understanding of some of the innovative features unique to the present disclosure and is not intended to be a full description. A full appreciation of the various aspects of the disclosure can be gained by taking the entire specification, claims, drawings, and abstract as a whole.

The above need is addressed by electrochemical cells provided in this disclosure. Provided are electrochemical primary cells that exhibit stable operating voltages of 0.3 V to 2.0 V, optionally 0.3 V to 1.5 V, optionally 0.3 V to 1.0 V, or 0.3 V to less than 1.0 V, that are capable of stable voltage and are capable of providing this stable voltage when configured in a volume of less than 0.5 cubic centimeters (cc) while also optionally providing relatively high capacity of 80 mAh or above. The objects of the disclosure are achieved by coupling a cathode that includes one or more Group 4A, 3A, or 5A elements either as a foil, or as other elemental or alloy form optionally fused to a conductive substrate, where the cathode is electrically coupled with an anode that includes Li, optionally Li metal, lithiated carbon, lithium-aluminum alloys, lithium-tin alloys, or lithiated silicon. The cell may include a non-aqueous electrolyte and optionally a lithium-ion conductive and electrically insulating separator inserted between the anode and the cathode. The inclusion of one or more Group 4A, 3A, or 5A elements in a cathode against a Li containing anode allows for the first time for stable voltage over the useful lifetime of the cell providing the ability, in some aspects, to adequately power ultra-low power devices, optionally without the need for a voltage step down circuit or other voltage modifying systems.

The cathodes are optionally elemental metal alone such as in the form of a foil, are thermally or otherwise fused to a conductive substrate, or are bound to a conductive substrate by traditional methods such as with the inclusion of a binder (and optionally a conductive additive) and through slurry coating onto the substrate. When in the form of a foil, a cathode is optionally substantially free of native surface oxide where the native surface oxide is optionally removed by physical or electrochemical methods.

In some aspects, a non-aqueous electrolyte includes a lithium salt and an organic solvent. An electrolyte optionally has a vapor pressure of less than 5 mm Hg at standard temperature and pressure, optionally less than 0.2 mm Hg at standard temperature and pressure. An electrolyte may be a liquid electrolyte, a gelled electrolyte, or a solid polymer electrolyte.

The cells may be used alone or coupled either in series or in parallel to provide desired power to an associated device.

In some aspects, an electrochemical cell is provided with a stable voltage under 1.0 V. In some aspects a volumetric cell capacity or a provided cell is greater than 100 Ah/L, optionally greater than 500 Ah/L. The electrochemical cells are optionally specifically designed for use with the ultra-low power devices such as ‘internet of things’ devices. While in some aspects, an electrochemical cell is a primary cell. Optionally, an electrochemical cell is a secondary cell. Optionally, an electrochemical cell is not a secondary cell.

### BRIEF DESCRIPTION OF THE DRAWINGS

The aspects set forth in the drawings are illustrative and exemplary in nature and not intended to limit the subject matter defined by the claims. The following detailed description of the illustrative aspects can be understood when read in conjunction with the following drawings, in which:

FIG. 1 illustrates voltages of a Li/Sn CR2025 coin cell discharged at varied current densities and temperatures where the current densities correspond to 1 μA passed by cells of diameters 2 cm, 1.6 cm, 1.2 cm, and 1.1 cm;

FIG. 2 illustrates voltages of 2 replicate Li/Al CR2025 coin cells discharged at indicated current densities and temperatures where current densities correspond to 1 μA passed by cells of diameters A) 2 cm, B) 1.6 cm, C) 1.2 cm, and D) 1.1 cm;

FIG. 3 illustrates voltages of 2 Li/Al CR2025 coin cells, one cell being made with Al foil as received and the other being an Example 2 cell, discharged at ambient temperature at indicated currents;

FIG. 4 illustrates voltages of 2 Li/Al CR2025 coin cells, one cell being made with Al foil abraded in air and the other being an Example 2 cell, discharged at ambient temperature at indicated currents;

FIG. 5 illustrates voltages of 2 Li/Al CR2025 coin cells, one cell being made with Al foil coated with abrasive boron powder and calendered in air and the other being an Example 2 cell, discharged at ambient temperature at indicated currents;

FIG. 6 illustrates voltages of 3 Li/Al CR2025 coin cells, two cells being made with cathodes consisting of Al powder coated on copper foil and then calendered in air or not, and the other being an Example 2 cell, discharged at ambient temperature at indicated currents; and

FIG. 7 illustrates voltage of a Li/Si CR2025 coin cell made according to some aspects as provided herein with cathode consisting of Si powder coated on copper foil, discharged versus a Li foil anode at 0.13 mA at ambient temperature.

### DETAILED DESCRIPTION

The following description is merely exemplary in nature and is in no way intended to limit the scope of the invention, its application, or uses, which may, of course, vary. The description is presented with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, the term “stable” when referring to an operating voltage is defined as exhibiting a variance of less than or equal to 10%, optionally 5%, over a capacity range of 100 mAh per cubic centimeter of cell volume.

As defined herein, an “anode” or “negative electrode” includes a material that acts as an electron donor during discharge.

As defined herein, a “cathode” or “positive electrode” includes a material that acts as an electron acceptor during discharge.

As defined herein, a “cell” is as understood in the art including a cathode, an anode electrically coupled to the cathode, and an electrolyte located physically between the cathode and the anode. A cell may include a separator between the anode and the cathode.

As defined herein, a “battery” is two or more cells electrically coupled.

A Group 3A element as used herein is B, Al, Ga, or In.

A Group 4A element as used herein is Si, Ge, Sn, or Pb.

A Group 5A element as used herein is As, Sb, or Bi.

Provided are relatively non-toxic lithium-ion electrochemical cells that exhibit a stable cell voltage under 2.0 V, optionally under 1.5 V, optionally under 1.2 V, optionally under 1.0 V, and also exhibiting a volumetric capacity greater than 100 Ah/L, optionally greater than 500 Ah/L. Such cells are formed using a lithium metal anode and a cathode comprising one or more transition metal elements or one or more Group 3A, 4A, or 5A elements.

The cell chemistries on which the provided cells according to this disclosure are based are electrochemical alloying reactions that proceed by the general reaction:

nLi+M→LiₙM

where M includes a Group 3A, 4A, or 5A metal or metalloid and Zn. The Group 3A, 4A, or 5A metal can also be an alloy that includes one or more Group 3A, 4A, or 5A metal or metalloid or one or more Group 3A, 4A, or 5A element with one or more transition metals. Examples of alloys that include one or more Group 3A, 4A, or 5A element illustratively include bronze, brass, silicon-tin, germanium-tin, niobium-tin, tin-silver-copper, tin-bismuth alloy, tin-antimony alloy, tin-copper alloy, tin-nickel alloy, gallium-copper alloy, gallium-indium-copper alloy, tin-lead alloy, babbitt alloy, or white metal.

In some aspects, M is or includes B, Al, Ga, In, Si, Ge, Sn, Pb, As, Bi or Sb. Optionally, M excludes Sb, Pb, or In when used alone absent a second element in an alloy.

Optionally, M is or includes an alloy. Illustrative examples of an alloy include a tin-bismuth alloy, tin-antimony alloy, tin-copper alloy, tin-nickel alloy, gallium-copper alloy, gallium-indium-copper alloy, gallium-tin-copper, or tin-lead alloy. An alloy, in some aspects, excludes an Al/Mg alloy, Al/Cu alloy, or a Al/Mn alloy.

An alloy is optionally an alloy of 1, 2, 3, 4, or more metals or metalloids, with another metal or metalloid and optionally including one or more transition metals. The relative amounts of each of the metals may be from 1 weight percent to 99 weight percent. Optionally, an alloy includes one metal or metalloid as a predominant relative to the total metal or metalloid content of the alloy. In a two metal alloy a first metal is optionally 80 weight percent to 99 weight percent, and a second, third, fourth or further metal is optionally 20 weight percent or lower.

Optionally, M is or includes a tin-antimony alloy. The tin-antimony alloy is optionally coupled in a cell with an anode of Li metal, lithiated carbon, lithium-aluminum alloys, lithiated-tin alloys, or lithiated silicon. A tin-antimony alloy is optionally predominantly tin or predominantly antimony. In some aspects, the antimony is present at 0.1 to 88 weight percent, optionally 0.1 to 44 weight percent, optionally 44 to 61 weight percent, optionally 1 to 3 weight percent, optionally 1 to 2 weight percent, optionally 2 to 5 weight percent.

Optionally, M is or includes a Ga/Cu alloy. The Ga/Cu alloy is optionally coupled in a cell with an anode of Li metal, lithiated carbon, lithium-aluminum alloys, lithiated-tin alloys, or lithiated silicon. A Ga/Cu alloy is optionally predominantly Ga. In some aspects, the Ga is present at 60 to 90 weight percent, optionally 66-69 weight percent (corresponding to CuGa₂). The Ga/Cu alloy is optionally thermally or otherwise fused or contacted with a Cu foil substrate.

Optionally, M is or includes a Ga/In/Cu alloy. The Ga/In/Cu alloy is optionally coupled in a cell with an anode of Li metal, lithiated carbon, lithium-aluminum alloys, lithiated-tin alloys, or lithiated silicon. A Ga/In/Cu alloy is optionally predominantly Ga or predominantly In. In some aspects, the Ga is present at 0.1 to 99 weight percent. The In is optionally present at 0.1 to 99 weight percent. The Cu is optionally present at 30-35 weight percent, optionally 31-32 weight percent (corresponding to GaₓIn₂₋ₓCu). The Ga/In/Cu alloy is optionally thermally or otherwise fused to a Cu foil substrate.

Optionally, M is or includes a Ga/As alloy. The Ga/As alloy is optionally coupled in a cell with an anode of Li metal, lithiated carbon, lithium-aluminum alloys, lithiated-tin alloys, or lithiated silicon. A Ga/As alloy is optionally predominantly Ga or predominantly As. In some aspects, the As is present at 50 weight percent or greater, optionally 52 weight percent or greater.

Optionally, M is or includes a Ga/Sb alloy. The Ga/Sb alloy is optionally coupled in a cell with an anode of Li metal, lithiated carbon, lithium-aluminum alloys, lithiated-tin alloys, or lithiated silicon. A Ga/Sb alloy is optionally predominantly Ga or predominantly Sb. In some aspects, the Sb is present at 50 weight percent or greater, optionally 60 weight percent or greater, optionally 63-64 weight percent.

Optionally, M is or includes a Ga/Sn alloy. The Ga/Sn alloy is optionally coupled in a cell with an anode of Li metal, lithiated carbon, lithium-aluminum alloys, lithiated-tin alloys, or lithiated silicon. A Ga/Sn alloy is optionally predominantly Ga or predominantly Sn. In some aspects, the Sn is present at 20 weight percent or greater, optionally 25 weight percent or greater, optionally 30 weight percent or greater, optionally 40 weight percent or greater, optionally 50 weight percent or greater, optionally 60 weight percent or greater, optionally 70 weight percent or greater, optionally 80 weight percent or greater, optionally 90 weight percent or greater, optionally 95 weight percent or greater, optionally 96.1 weight percent. The Ga/Sn alloy is optionally thermally or otherwise fused to a Cu foil substrate.

Optionally, M is or includes Pb or a Pb alloy. The Pb cathode is optionally coupled in a cell with an anode of Li metal, lithiated carbon, lithium-aluminum alloys, lithiated-tin alloys, or lithiated silicon.

Optionally, M is or includes a Pb/Sb alloy. The Pb/Sb alloy is optionally coupled in a cell with an anode of Li metal, lithiated carbon, lithium-aluminum alloys, lithiated-tin alloys, or lithiated silicon. A Pb/Sb alloy is optionally predominantly Pb or predominantly Sb. In some aspects, the Sb is present at 1 weight percent or greater, optionally 3 weight percent or greater, optionally 3 to 99 weight percent, optionally 18 to 90 weight percent.

Optionally, M is or includes a Pb/In alloy. The Pb/In alloy is optionally coupled in a cell with an anode of Li metal, lithiated carbon, lithium-aluminum alloys, lithiated-tin alloys, or lithiated silicon. A Pb/In alloy is optionally predominantly Pb or predominantly In. In some aspects, the In is present at 20 weight percent or greater, optionally 30 weight percent or greater, optionally 20 to 50 weight percent, optionally 24 to 44 weight percent.

Optionally, M is In or includes an alloy of In. The cathode M is optionally coupled in a cell with an anode of Li metal, lithiated carbon, lithium-aluminum alloys, lithiated-tin alloys, or lithiated silicon.

Optionally, M is or includes a In/Sb alloy. The In/Sb alloy is optionally coupled in a cell with an anode of Li metal, lithiated carbon, lithium-aluminum alloys, lithiated-tin alloys, or lithiated silicon. A In/Sb alloy is optionally predominantly In or predominantly Sb. In some aspects, the Sb is present at 40 weight percent or greater, optionally 50 weight percent or greater, optionally 40 to 60 weight percent, optionally 48 to 56 weight percent.

Optionally, M is or includes a In/Sn alloy. The In/Sn alloy is optionally coupled in a cell with an anode of Li metal, lithiated carbon, lithium-aluminum alloys, lithiated-tin alloys, or lithiated silicon. A In/Sn alloy is optionally predominantly In or predominantly Sn. In some aspects, the Sn is present at 10 weight percent or greater, optionally 30 weight percent or greater, optionally 10 to 95 weight percent, optionally 13 to 17 weight percent, optionally 17 to 33 weight percent, optionally 33 to 70 weight percent, optionally 70 to 88 weight percent, optionally 88 to 95 weight percent.

Optionally, M is or includes Bi or a Bi alloy. The Bi cathode is optionally coupled in a cell with an anode of Li metal, lithiated carbon, lithium-aluminum alloys, lithiated-tin alloys, or lithiated silicon.

Optionally, M is or includes a Bi/Sb alloy. The Bi/Sb alloy is optionally coupled in a cell with an anode of Li metal, lithiated carbon, lithium-aluminum alloys, lithiated-tin alloys, or lithiated silicon. A Bi/Sb alloy is optionally predominantly Bi or predominantly Sb. In some aspects, the Sb is present at 1 weight percent or greater, optionally 50 weight percent or greater, optionally 1 to 90 weight percent.

Optionally, M is or includes a Bi/Sn alloy. The Bi/Sn alloy is optionally coupled in a cell with an anode of Li metal, lithiated carbon, lithium-aluminum alloys, lithiated-tin alloys, or lithiated silicon. A Bi/Sn alloy is optionally predominantly Bi or predominantly Sn. In some aspects, the Sn is present at 10 weight percent or greater, optionally 50 weight percent or greater, optionally 50 to 60 weight percent, optionally 56 to 58 weight percent.

Optionally, M is or includes a Bi/In alloy. The Bi/In alloy is optionally coupled in a cell with an anode of Li metal, lithiated carbon, lithium-aluminum alloys, lithiated-tin alloys, or lithiated silicon. A Bi/In alloy is optionally predominantly Bi or predominantly In. In some aspects, the In is present at 30 weight percent or greater, optionally 40 weight percent or greater, optionally 50 weight percent or greater, optionally 35 to 36 weight percent, optionally 47 to 48 weight percent, optionally 52 to 54 weight percent.

Optionally, M is or includes a Bi/Ga alloy. The Bi/Ga alloy is optionally coupled in a cell with an anode of Li metal, lithiated carbon, lithium-aluminum alloys, lithiated-tin alloys, or lithiated silicon. A Bi/Ga alloy is optionally predominantly Bi or predominantly Ga. In some aspects, the Ga is present at 1 weight percent or greater, optionally 30 weight percent or greater, optionally 50 weight percent or greater, optionally 1 to 90 weight percent.

Prior electrochemical characterization of Group 3A, 4A, and 5A elements has focused on their cycling characteristics rather than on their initial lithiation, which can present a voltage characteristic that differs substantially from that of subsequent lithiation during reversible cycling. For example, the initial lithiation of crystalline Si takes place on a very flat potential plateau at about 0.1 V vs. Li, whereas upon subsequent cycling, electrochemical lithiation takes place at about 0.2 V vs. Li over a sloping potential range. The initial electrochemical lithiation processes for Sn and Al behave similarly, with high capacities and stable potentials vs. Li that are under 1.0 V. A family of low voltage primary Li batteries with tailorable voltages can optionally be made based on cells having Li opposite Al, Sn, and Si as summarized in Table 2.

TABLE 2
Voltage and materials-only volumetric capacity of electrochemical
couples based on initial lithiation of Al, Sn and Si when used in
cells of the indicated configuration according to this disclosure.

| # of series cells | Cell couples | Measured voltage | Materials mAh/cc |
|---|---|---|---|
| 1 | Li/Si | 0.11 V | 1630 |
| 1 | Li/Al | 0.34 V | 1161 |
| 1 | Li/Sn | 0.53 V | 1522 |
| 2 | Li/Al + Li/Si | 0.45 V | 678 |
| 2 | Li/Sn + Li/Si | 0.64 V | 787 |
| 2 | 2 × Li/Al | 0.68 V | 580 |

As cell sizes decrease, the proportion of their total volume available for active materials decreases as well. Therefore, for the very small cells needed in low voltage unattended sensor and internet of things applications, it is beneficial that active materials-only volumetric capacities far exceed the required cell-level volumetric capacities.

In some applications a battery voltage of 0.3 to 2.0 V, optionally 0.3 to 1.5 V, optionally 0.3 to 1 V is desired. The exemplary illustration demonstrated in Table 2 shows that although the Li/Si cell chemistry will not by itself provide a voltage in this desired range, it can be combined in series with either the Li/Al or Li/Sn cell chemistries to tailor the operating voltage.

Table 2 also shows that when cells are combined in series, although the output voltage is increased, the material-only volumetric capacity is greatly decreased; for example, 2 Li/Al cells in series will provide twice the voltage of a single cell, but will have half the active materials-only volumetric capacity of a single cell, because twice as much Li and Al are used in delivering the same amount of capacity. However, in this example the material-only volumetric capacity still exceeds 500 Ah/L, and thus can still provide cells delivering over 100 Ah/L with only ⅕^{th} of their volume occupied by active materials.

As such, electrochemical cells are provided that include a cathode that includes one or more Group 3A, 4A, or 5A element, opposed an anode comprising Li, where the cell as a stable voltage of 0.3 to 2.0 V, optionally 0.3 to 1.5 V, optionally 0.3 to 1 V, and where the cell exhibits a volumetric capacity of 500 Ah/L or greater. Optionally a volumetric capacity is at or greater than 100 Ah/L, optionally 150 Ah/L, optionally 200 Ah/L, optionally 250 Ah/L, optionally 300 Ah/L, optionally 400 Ah/L, optionally 500 Ah/L, optionally 600 Ah/L, optionally 800 Ah/L, optionally 1000 Ah/L, optionally 1200 Ah/L, optionally 1500 Ah/L.

A cathode is optionally in the form of a foil, a coated substrate, foil coated substrate or a molten element or alloy that is subsequently alloyed with a conductive substrate. A Group 3A, 4A, or 5A is optionally present in elemental form, optionally in the form of a powder. The powder is optionally formed into a foil, or is combined with a binder or other optional agent (e.g., conductive agent, etc.) to coat a conductive substrate. Methods of forming foils or elemental metals are known in the art. Illustratively, the source metal is melted into a suitable source form and then formed into a sheet of desired thickness. A foil thickness is optionally 0.01 mm to 10 mm in thickness. Optionally, 0.2 mm to 2 mm, optionally 0.25 mm to 1 mm. Other foil thickness are optionally provided.

The cathode of the provided cells can be a metal foil or cathode powder composite comprising a transition metal or alloy or Group 3A, 4A or 5A element or alloy. In the case of a metal foil, some metal foils, such as aluminum foil, have a passivating native oxide film that can have a very high impedance and prevent cell discharge. In this case, the native oxide can be removed prior to cell assembly by abrasion such as with a 2000 grit sandpaper under inert atmosphere to prevent re-oxidation prior to cell assembly.

Another method of removing the native oxide film on aluminum foil is to coat the foil with an abrasive powder combined with a polymer binder followed by calendering in air or under inert atmosphere. The calendering action grinds the abrasive powder over the metal surface and abrades the native oxide layer, exposing fresh metal. The calendering pressure should be sufficient to sufficiently abrade the surface oxide coating of the aluminum foil. The presence of the polymer binder then blocks oxygen access and prevents reoxidation of the metal foil surface. Since the abrasive powder coating becomes part of the cell cathode it is desirable for it to be electrochemically inert to lithium reduction. Illustrative abrasive powders include boron (optionally submicron boron), iron, and tungsten carbide. The polymer binder should be electrochemically inert in contact with the cathode powder and not be dissolved by cell electrolyte. Suitable binders include but are not limited to polyvinylidene fluoride, polybutadiene-styrene, polyisobutylene, polyisoprene, ethylene-propylene diene and polyacrylic acid. The amount of abrasive powder relative to polymer binder can be 70-90% by weight. In addition to a first abrasive powder, a second non-abrasive powder such as acetylene black, graphite, or graphene can be added. An abrasive powder is optionally present as a predominate, optionally 50% or more by weight, optionally 60% or more by weight, optionally 79% or more by weight, optionally 80% or more by weight where the percent by weight is relative to the abrasive powder, polymer binder, and secondary non-abrasive powder. A non-abrasive powder is optionally present at 1 to 10% by weight, optionally 2 to 10% by weight. A polymer binder is optionally present at 1 to 10% by weight, optionally 2 to 10% by weight. In some aspects the ratio of abrasive to non-abrasive powder to binder can be 80:10:10 by weight.

In the case of a cathode powder composite, the cathode can be composed of the cathode active element powder and a binder, optionally a polymer binder, coated onto a conductive substrate (e.g., copper foil) with or without a conductive additive (e.g., acetylene black, graphite or graphene). When a powder active is used, the active may be formed into a slurry. The cathode coating slurry can be prepared by dissolving a binder in a solvent optionally followed by dispersing the cathode active powder and optionally a conductive additive. The slurry can be cast onto a conductive substrate such as copper foil, dried, and calendered.

Calendering can be required for some metal powders such as aluminum to fracture the passivating high impedance native oxide surface and allow cell discharge. Calendering can be performed under inert atmosphere or in air. The calendering pressure should be sufficient to substantially abrade or crack the surface oxide coating of the aluminum powder. In the case of air calendering, the presence of the cathode binder can block oxygen and prevent reoxidation of the fresh aluminum surface. The polymer binder should be substantially chemically stable in contact with the active cathode powder and should not be dissolved by cell electrolyte. Illustrative binders include but are not limited to polyvinylidene fluoride, polybutadiene-styrene, polyisobutylene, polyisoprene, ethylene-propylene diene, and polyacrylic acid. Suitable conductive additives include but are not limited to acetylene black, graphite, and graphene.

Yet another method for removing the native oxide from the surface of aluminum foil or powder composite is electrochemical etching or electrochemical activation. This method does not require mechanical abrasion and can be performed in-situ which may be more practical than abrasion.

For oxide removal using electrochemical etching or electrochemical activation, following cell assembly the cell is initially charged to a voltage higher than 0.5 V, or optionally higher than 1.0 V, or optionally higher than 1.5 V depending on the electrolyte. While not wanting to be bound by any particular theory, it is believed the electrically insulative aluminum oxide surface is dissolved in a suitable electrolyte salt. Suitable electrolyte salts include lithium tetrafluoroborate (LiBF₄), lithium bis(trifluoromethanesulfonyl)imide (LiTFSi), lithium bis(fluorosulfonyl)imide (LiFSi), and lithium trifluoromethanesulfonate (LiTFS). For example, when the electrolyte is comprised of LiTFS salt, the cell can be initially charged to around 3 V or more in order to electrochemically activate the aluminum. In the case of LiTFSi and LIFSi the cell can be initially charged to 4 V or more to activate the aluminum. In the case of LiBF₄ the cell can be initially charged to more than 4.5 V to activate the aluminum.

In some aspects, a cathode active material includes tin. Tin, however, is subject to a temperature dependent crystalline phase transformation that may affect cell operation below 14° C. Below 14° C. tin can transform from a β-form allotrope consisting of a ductile metallic white-tin with a body centered tetragonal crystal structure, to a α-form allotrope consisting of a brittle, nonmetallic, grey-tin with a face centered cubic diamond structure. Since a tin has a lower density than β tin (5.77 vs 7.26 g/cc respectively) and is much less ductile, the cold temperature induced transformation of β to α tin may result in pulverization of a tin foil cathode into a powder resulting in loss of electrical contact and or cell shorting and ultimately cell failure. The β-α crystalline phase transformation can be accelerated with lower environmental temperatures. The temperature dependent β-α crystalline phase transformation can be inhibited by alloying tin with other elements such as bismuth, antimony, lead, copper, silver and gold, most notably bismuth, antimony and lead additives. In the case of bismuth, antimony and lead an additive concentration of about 0.3, 0.5 and 5% respectively is sufficient to inhibit tin β-α crystalline phase transformation.

Another potential problem with tin is a phenomenon commonly known as tin whiskers. The mechanism is not well understood but seems to be accelerated by residual compressive mechanical stresses and results in dendritic metallic growths projecting out of the tin surface. These tin dendrites can potentially penetrate the cell separator and short the cell. Tin whiskers on tin foil or powder can be inhibited by thermally annealing and or addition of other metals such as lead, copper and nickel.

In some aspects a cathode active material includes an element or alloy from a Group 3A, 4A or 5A element that is liquid below 100° C. or below the operating temperature of the cell. In such a case the cell could short internally. In order to avoid shorting the element or alloy can be further alloyed with another element that would raise the melting point above the operating temperature of the cell or above 100° C. For example, Ga or Ga/In alloy which is liquid below 40° C. can be alloyed with Cu. The subsequent Ga/Cu or Ga/In/Cu alloy can have a melting point above 100° C. In the case of Ga, the amount of Cu needed to raise the melting point of the alloy above the operating temperature of the cell can be greater than 20 atomic %.

The alloy with Cu can be formed by heating Ga or Ga/In alloy with Cu powder for a period of time. For example, above 100° C. or optionally above 150° C. for a period more than 1 hour or optionally more than 10 hours. In another example the Ga or Ga/In alloy can be mechanically applied to the surface of a Cu foil then heated to more than 100° C. or optionally 150° C. for a period more than 1 hour or optionally more than 10 hours. Alloying with Cu foil or Cu powder can be assisted by removing the surface oxidation from the Cu foil or powder. This can be done by cleaning the copper foil or powder with an acid such as hydrochloric acid followed by washing with water.

The anode of the provided electrochemical cells is or includes Li metal. The Li metal is optionally a predominant. Illustrative examples of an anode include Li metal, lithiated carbon, lithium-aluminum alloys, lithiated-tin alloys, and lithiated silicon. The anode can be in the form of a foil or a powder composite. If the anode is in the form of a foil, a foil thickness is optionally 0.01 mm to 10 mm in thickness. Optionally, 0.2 mm to 2 mm, optionally 0.25 mm to 1 mm. If the anode includes a powder composite, the lithium powder can be blended with a binder and a solvent to prepare a slurry. The binder can be a polymer binder that is substantially chemically stable in contact with lithium and is not dissolved by electrolyte. Examples of lithium stable polymers illustratively include polybutadiene-styrene, polyisobutylene, polyisoprene and ethylene-propylene diene. The anode coating slurry can be prepared by dissolving the anode binder in solvent followed by dispersing the lithium powder. The solvent choice is generally non-polar for these non-polar binders, and must not substantially react with lithium. For example, if the binder is polyisoprene, a suitable solvent would be xylene or heptane or mixtures thereof. The anode slurry is then coated onto a conductive substrate such as copper foil and dried under low humidity conditions to prevent corrosion of the lithium powder.

As indicated, an anode includes lithium. The anode may be in the form of a lithium metal such as elemental lithium either in a foil or other form, or may include other elements. Other illustrative examples of an anode include lithiated carbon, lithium-aluminum alloys, lithiated-tin alloys, and lithiated silicon. Li alloy anodes are able to provide desirable voltage characteristics opposite cathodes comprising group 3A, 4A, and 5A elements and alloys thereof. Table 3 shows voltages of exemplary group 3A, 4A, and 5A cathodes discharged in size 2025 Li-anode coin cells made with 1M LiFSI in 1/1 EC/EMC electrolyte at currents ranging from 1 μA to 100 μA. Using a given cathode material, cell voltage can be adjusted to a desired value by appropriate selection of a Li alloy anode material.

TABLE 3

| | Voltage versus various Li anodes | | | |
|---|---|---|---|---|
| | V vs. | V vs. | V vs. | V vs. |
| Cathode Material | Li | Li—Si | Li—Al | Li—Sn |
| In | 1.37 | 1.26 | 1.03 | 0.84 |
| Pb | 0.53 | 0.42 | 0.19 | |
| Sb | 0.87 | 0.76 | 0.53 | 0.34 |
| 60/40 wt % In/Ga alloy | 1.27 | 1.16 | 0.93 | 0.74 |
| 92/8 wt % Ga/Sn alloy | 0.5 | 0.39 | 0.16 | |
| Ga/Cu alloy | 0.5 | 0.39 | 0.16 | |

Storage life and activated life are greatly affected by self-discharge and corrosion reactions. These properties can be primarily affected by electrolyte. For low cell self-discharge as well as good thermal stability, it is desirable to use chemically and thermally stable electrolytes that passivate Li metal. Li cell electrolyte solvents are not intrinsically stable at the low potentials of Li metal or Li alloy electrodes. However, good Li electrolytes undergo film-forming reductive reactions at low potential electrode surfaces that effectively passivate the electrodes without compromising their electrochemical activity. This is possible because the films formed (known as solid electrolyte interphase or SEI) are dense electronic insulators but are good ionic conductors, thus preventing further reduction of the electrolyte by the electrode, but enabling electrochemical activity by supporting Li⁺ ion exchange between the electrode and the electrolyte. Examples of SEI-enhancing solvents that may be included in an electrolyte include ethylene carbonate, fluoro-ethylene carbonate and propylene carbonate. Electrolyte decomposition can also affect the presence of redox shuttling impurities capable of self-discharging the cell, and must therefore be avoided by proper choice of salt, solvent and additives. Finally, some fluorine-containing electrolyte salts, such as LiPF₆, can decompose, especially in the presence of trace amounts of water, and form corrosive impurities such as phosphorus pentafluoride (PF₅) and hydrofluoric acid (HF), that are capable of diminishing cell shelf life.

Examples of suitable Li electrolyte salts include but are not limited to lithium hexafluorophosphate (LiPF₆), lithium bistrifluoromethanesulfonylimide (LiTFSI), lithium triflate (LiTFS), lithium tetrafluoroborate (LiBF₄, lithium bis(fluorosulfonyl)imide(LiFSI) and lithium iodide (LiI). LiTFSI, LiFSI and LiBF₄ have superior thermal and hydrolytic stability relative to LiPF₆.

Classes of suitable electrolyte solvents include but are not limited to carbonates, ethers, fluoro-substituted carbonates, fluoroalkyl-substituted carbonates, hydrofluoro ethers, fluoroalkyl substituted ethers and mixtures thereof. Example of specific solvents include but are not limited to ethylene carbonate, propylene carbonate, butylene carbonate, dimethyl carbonate, ethyl-methyl carbonate, diethyl carbonate, 1,2-dioxolane and mixtures thereof.

In Li metal cells, bulk carbonate solvents such as PC often passivate Li well enough to provide very robust performance and life. Li-ion cells frequently employ low concentrations (e.g., ˜1%) of special SEI-forming additives to passivate their anodes. Such additives can further reduce self-discharge and extend cell life of low voltage cells. Examples of such additives include but are not limited to vinylene carbonate (VC), fluoroethylene carbonate (FEC), lithium Bis(oxalato)borate (LiBoB), various organic sulfur oxides such as 1,2 propane sultone, and tri(hexafluoro-iso-propyl) phosphate (HFIP).

Cell life can also be enhanced by minimizing electrolyte lost to evaporation or leakage thru the cell seal. This can be achieved by using low or zero volatility electrolyte solvents. A non-aqueous electrolyte optionally has a low vapor pressure of less than 5 mm Hg at standard temperature and pressure (STP). An electrolyte optionally has a vapor pressure at STP at or less than 5 mm Hg, optionally 4 mm Hg, optionally 3 mm Hg, optionally 2 mm Hg, optionally 1 mm Hg, optionally 0.9 mm Hg, optionally 0.8 mm Hg, optionally 0.7 mm Hg, optionally 0.6 mm Hg, optionally 0.5 mm Hg, optionally 0.4 mm Hg, optionally 0.3 mm Hg, optionally 0.2 mm Hg, optionally 0.1 mm Hg. Illustrative low volatility electrolyte solvents can include carbonates having high boiling points, for example greater than 130° C., such as ethylene carbonate, propylene carbonate, or butylene carbonate combined with high boiling point ethers such as dimethoxyethane, bis(2-methoxyethyl) ether, triethylene glycol dimethyl ether, tetraethylene glycol dimethyl ether and mixtures thereof.

Zero volatility solvents include ionic liquids with a nitrogen, phosphorus or sulfur-based cation combined with an anion. Examples of suitable cation moieties include but are not limited to imidazolium, alkysubstituted imidazolium, ammonium, pyridinium, pyrrolidinium, phosphonium, or sulfonium and mixtures thereof. Examples of suitable anions include but are not limited to hexafluorophosphate, bistrifluoromethanesulfonimide, triflate, tetrafluoroborate, dicyanamide or iodide and mixtures thereof. An example of a suitable ionic liquid is 1-ethyl-3-methylimidazolium bis(trifluoromethanesulfonyl)imide. A small amount (less than 10% by weight) of lithium salt such as lithium bistrifluoromethanesulfonimide can be added to the ionic liquid for initial cell startup with low polarization.

In addition to low volatility liquid electrolytes, evaporation of electrolyte can be minimized by using an immobilized solid polymer electrolytes (SPE) optionally including a solid organic polymer (illustratively poly(ethylene oxide) (PEO)) complexed with a lithium salt. Illustrative examples of SPE are described in U.S. Pat. No. 5,599,355. Other SPEs include materials based on polycarbonate, polysiloxane, succinonitrile and organic-inorganic hybrid composites. The yield stress of the SPE is optionally higher than about 5 Pa to achieve sufficient mechanical strength to prevent flow. Examples of suitable salts for use with a SPE include but are not limited to lithium hexafluorophosphate, lithium bistrifluoromethanesulfonimide, lithium triflate, lithium tetrafluoroborate, lithium iodide, and mixtures thereof. In some illustrative aspects, SPE's can vary in PEO molecular weight and Li/EO ratio, and can also contain small quantities of low volatility plasticizing solvents in order to fine tune their mechanical properties and conductivities, especially at ambient temperatures and below. The dimensional changes of the electrodes during discharge can be significant as the Li anode will be consumed, while the cathode will expand to occupy its volume, with the inter-electrode interface moving as this occurs. Slippage of the electrolyte/electrode interface can also occur resulting in increased internal cell impedance and diminished power capability. In order to address this problem, the SPE can be rendered more flexible by incorporating a plasticizing solvent or ionic liquid.

As such, a solid polymer electrolyte optionally includes one or more plasticizing additives. A plasticizing additive optionally has a boiling point at 1 bar pressure of at or greater than 130° C., optionally 140° C., optionally 150° C. A plasticizing additive optionally includes an oligomeric ether. Specific illustrative examples of a plasticizing additive include but are not limited to bis(2-methoxyethyl) ether, triethylene glycol dimethyl ether, tetraethylene glycol dimethyl ether, or mixtures thereof. Optionally, a plasticizing additive includes an ionic liquid cation and an ionic liquid anion. An ionic liquid cation optionally includes imidazolium, alkysubstituted imidazolium, ammonium, pyridinium, pyrrolidinium, phosphonium, sulfonium moiety, or mixtures thereof. An ionic liquid anion optionally includes hexafluorophosphate, bistrifluoromethanesulfonamide, triflate, tetrafluoroborate, dicyanamide, iodide moiety, or mixtures thereof. The ionic liquid concentration in a plasticizing additive is optionally from 0.1 to 30 weight percent.

The ionic conductivity of SPEs is generally poor below their glass transition temperature (Tg), however plasticizers can lower the Tg. Typical PEO-salt complexes have Tg above 60° C. and consequently, very low ionic conductivity below 60° C. Thus, in addition to improving SPE flexibility, plasticizers can increase conductivity below 60° C. The concentration of plasticizer can range from 0.1 to about 30% by weight and the 1 bar boiling point of the plasticizer can be higher than 130° C. The plasticizer can be composed of a low volatility oligomeric ether such as bis(2-methoxyethyl) ether, triethylene glycol dimethyl ether, tetraethylene glycol dimethyl ether and mixtures thereof. Over-plasticization can result in mechanically weak SPE which can be extruded away from the electrode interface and initiate internal cell shorting. The yield stress of the plasticized SPE can be higher than about 5 Pa to achieve sufficient mechanical strength to prevent extrusion flow.

In addition to being plasticized with low volatility solvents, PEO-salt complexes can be plasticized with the aforementioned ionic liquids. The ionic liquid concentration can range from 0.1 to about 30% by weight.

Yet another example of an immobilized electrolyte is a gelled electrolyte wherein a liquid electrolyte is combined with an organic polymer. Optionally a gelled electrolyte includes an ionic liquid, a lithium salt, and an organic polymer that is substantially soluble in the ionic liquid. An organic polymer in a gelled electrolyte is optionally present in the electrolyte at a weight percent of 0.1 to 50%, optionally 0.1 to 30%. Suitable salts for gelled electrolytes can include but are not limited to lithium hexafluorophosphate, lithium bistrifluoromethanesulfonimide, lithium triflate, lithium tetrafluoroborate, lithium iodide and mixtures thereof. Suitable solvents for gelled electrolytes can include but are not limited to mixtures of organic carbonates, ethers, oligomeric ethers, fluoro-substituted carbonates, fluoroalkyl-substituted carbonates, hydrofluoro ethers, fluoroalkyl substituted ethers and mixtures thereof. The ionic liquid optionally includes a cation of an imidazolium, alkysubstituted imidazolium, ammonium, pyridinium, pyrrolidinium, phosphonium, sulfonium moiety, or mixtures thereof. The ionic liquid optionally includes an anion comprising hexafluorophosphate, bistrifluoromethanesulfonamide, triflate, tetrafluoroborate, dicyanamide, iodide, or mixtures thereof. A polymer used in a gelled electrolyte is optionally an organic polar solid. Suitable polymers for gelled electrolytes include but are not limited to poly(ethylene oxide), polyacrylate, polyvinylidene fluoride, poly(vinylidene fluoride-co-hexafluoropropylene) polyacrylonitrile, polystyrene-co-acrylonitrile, polyacrylamide, polyvinylacetate, polyurethane and mixtures thereof. The concentration of polymer required to achieve electrolyte gellation depends on the salt, solvent and polymer, and can range from about 1 to about 30%. Gelled electrolytes are intrinsically more flexible than SPE and can be superior at diminishing the rise in internal cell impedance caused by electrode migration during cell discharge. However, insufficient polymer concentration can weaken the gel sufficient to cause gel extrusion and subsequent internal shorting if no additional cell separator is in place. The yield stress of the gelled electrolyte can be higher than about 5 Pa to achieve sufficient mechanical strength to prevent flow. A specific example of a solid polymer electrolyte includes a poly(ethylene oxide) complexed with a lithium salt, where the lithium salt is any such salt described above.

A gelled electrolyte optionally includes one or more plasticizing additives. The concentration of plasticizing additive can range from 0.1 to about 50% by weight and the 1 bar boiling point of the plasticizer can be higher than 130° C. The plasticizing additive can be composed of a low volatility oligomeric ether such as bis(2-methoxyethyl) ether, triethylene glycol dimethyl ether, tetraethylene glycol dimethyl ether and mixtures thereof. The yield stress of the plasticized gel electrolyte can be higher than about 5 Pa to achieve sufficient mechanical strength to prevent extrusion flow.

Liquid electrolyte ionic conduction is strongly coupled to their interactions with cell separators and can be variable depending on several factors including separator porosity, pore size and particularly separator wetting properties which are dependent on electrolyte viscosity, electrolyte surface tension, separator surface tension and separator pore size. Separator surface tension is dependent on the separator material. A separator is optionally a microporous or non-woven polymer or a glass fiber separator. Illustrative examples of separator material include but are not limited to polyolefin, polyvinylidene fluoride, and glass fiber. Other illustrative examples of a separator material include polyolefin, cellulose, mixed cellulose ester, nylon, cellophane, and polyvinylidene fluoride. The order of increasing surface tension and wettability by electrolyte is glass fiber>polyvinylidene fluoride>polyolefin.

In the case of immobilized SPE there is no need for separator since the SPE is also the separator.

In another embodiment of the invention, stacked bipolar cells can be combined to provide several choices of voltages below 1.0 V in a single battery package. A bipolar electrode is a conductive substrate, such as copper, with the anode (Li) in electronic contact on one side and the cathode (i.e. Sn) in electronic contact on the other side. When two or more bipolar electrodes are stacked and connected in series their voltages are additive. For example, an assembly can be prepared in which a bipolar Li/Si electrode is positioned between a Sn electrode opposite its Li side (providing a 0.53 V cell), and a Li electrode on its Si side (providing a 0.11 V cell), and is separated from those respective Sn and Li electrodes by an immobilized electrolyte to yield a bipolar battery supplying 0.63 V. Bipolar stacked cells require the use of immobilized electrolytes such as the aforementioned SPE and gelled electrolyte to prevent inter-cell ionic crosstalk and resulting self-discharge of the bipolar electrode (Thus in the above example, preventing the Li of the bipolar electrode from reacting with the Si on its other side).

Various aspects of the present disclosure are illustrated by the following non-limiting examples. The examples are for illustrative purposes and are not a limitation on any practice of the present invention. It will be understood that variations and modifications can be made without departing from the spirit and scope of the invention

### EXAMPLES

### Example 1—Sn Cathode

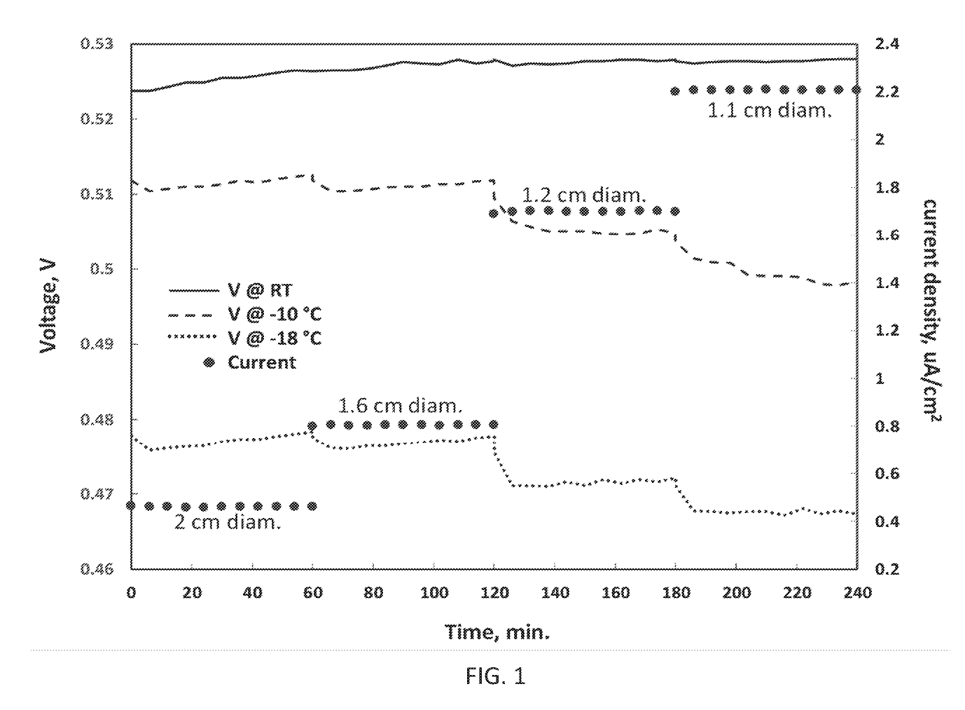

Size 2025 Li/Sn coin cells were built with 127 μm thick Li foil anodes (˜57 mAh calculated capacity), 25 μm thick Sn foil cathodes from Alfa-Aesar Inc. (˜32 mAh calculated capacity), Celgard 2500 separator, and were filled with 1M LiPF₆, 1/1/1 EC/DMC/EMC electrolyte. Cells were assembled in an Ar-atmosphere dry box, and the Sn foil was used as received. The cells were pre-discharged to a stable voltage of 0.53 V, and were then discharged at ambient temperature (RT), −10° C. and −18° C., at current densities corresponding to 1 μA delivered by cells with external diameters of 2 cm (0.46 μA/cm², 1 μA in test cell), 1.6 cm (0.79 μA/cm², 1.73 μA in test cell), 1.2 cm (1.69 μA/cm², 3.70 μA in test cell) and 1.1 cm (2.17 μA/cm², 4.72 μA in test cell), with discharge steps lasting 1 hour at each current density. FIG. 1 shows the results for one such coin cell. At ambient temperature (RT), the voltage closely coincides and essentially corresponds to the open circuit voltage (OCV) of about 0.53 V, showing that cells with diameters at least as small as 1.1 cm will readily support currents up to 1 μA with no voltage variation. At −10° C. the cell's voltage is lower, but still is over 90% of OCV, while at −18° C., the cell's voltage is still over 85% of OCV at all current densities. After these tests were completed, the cell was fully discharged (to 0.1 V cutoff) at relatively high current (3 mA), delivering ˜27 mAh, or ˜85% of its theoretical capacity. This example shows that the Li/Sn system when implemented with thicker foils will meet the requirement of <10% variation in voltage in a cell that delivers >100 mAh/cc.

### Example 2—Al Foil Cathode Abraded with 2000 Grit Sandpaper Under Argon

Size 2025 Li/Al coin cells were built with 127 μm thick Li foil anodes, 20 μm thick Al foil (Alfa-Aesar Inc.) cathodes, Celgard 2500 separator, and were filled with 1M LiPF₆, 1/1/1 EC/DMC/EMC electrolyte. Before assembling the cells in an Ar-atmosphere dry box, both sides of the Al foil cathodes were buffed with 2000 grit paper to remove passivating native oxide.

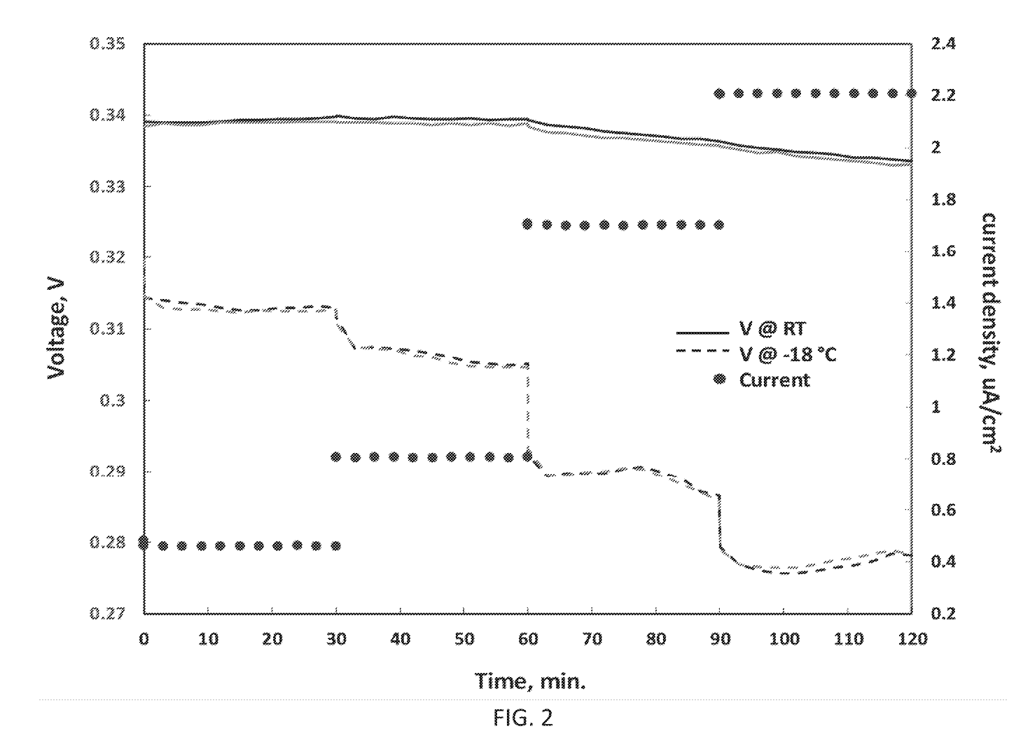

Cells were pre-discharged to 0.34 V and underwent a number of electrochemical characterization procedures before being tested under a protocol similar to that used for Example 1 Li/Sn cells, but with discharge steps lasting for 30 rather than 60 minutes, and without discharge tests at −10° C. FIG. 2 shows the results for 2 identically made and tested coin cells. The 2 cells' voltages closely coincide at both RT and −18° C., showing that the Al foil anodes were uniformly activated by having been buffed in the dry box prior to cell assembly. The results showed slightly increasing voltage polarization with increasing current density at RT, and polarization of less than 20% at all current densities at −18° C. The Li/Al cells were ultimately fully discharged (to 0.1 V cutoff) and delivered total capacity of ˜12 mAh, in good agreement with theoretical expectation. This example shows that the Li/Al system when implemented with thicker foils will meet the requirement of <10% variation in voltage in a cell that delivers >100 mAh/cc.

### Example 3—Aluminum Foil Cathode not Abraded

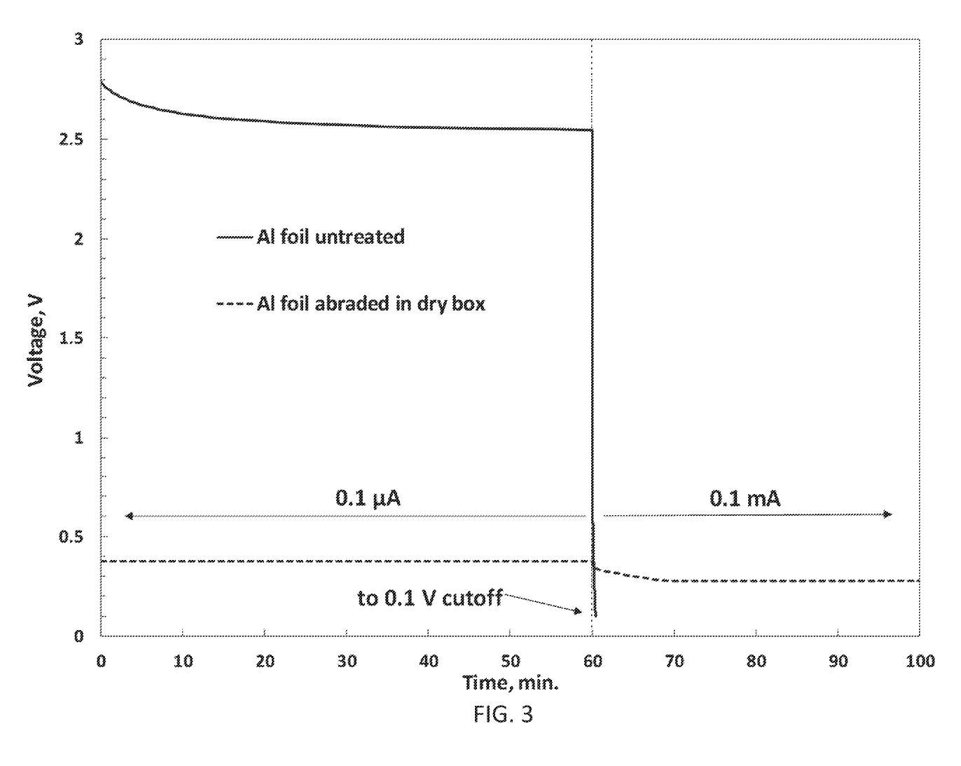

Size 2025 Li/Al coin cells were built with 127 μm thick Li foil anodes, 20 μm thick Al foil cathodes, Celgard 2500 separator, and were filled with 1M LiPF6 1/1/1 EC/DMC/EMC electrolyte. The Al foil was used as received and cells were assembled in an Ar-atmosphere dry box. The cells were then discharged at ambient temperature (RT) by a protocol in which they were first discharged at 0.1 μA for 1 hour, were then discharged at 0.1 mA for 1 hour, and were then allowed to rest for 10 hours before repeating this sequence. FIG. 3 compares results for the 8^{th} discharge sequence of one such cell made with untreated Al foil to results for the 3^{rd} discharge of an Example 2 cell made with Al foil abraded in the Ar-atmosphere dry box. The cell with an untreated (not abraded) Al foil cathode had voltage above 2 V at low current of 0.1 μA but could not sustain high current of 0.1 mA at all, consistent with it having a passivating oxide coating that was only electrochemically active at extremely low current density, whereas the Example 2 cell Al cathode surface sustained voltage between 0.4 V and 0.2 V at both currents, showing that it was highly active for electrochemical alloying with Li.

### Example 4—Aluminum Foil Cathode Abraded in Air

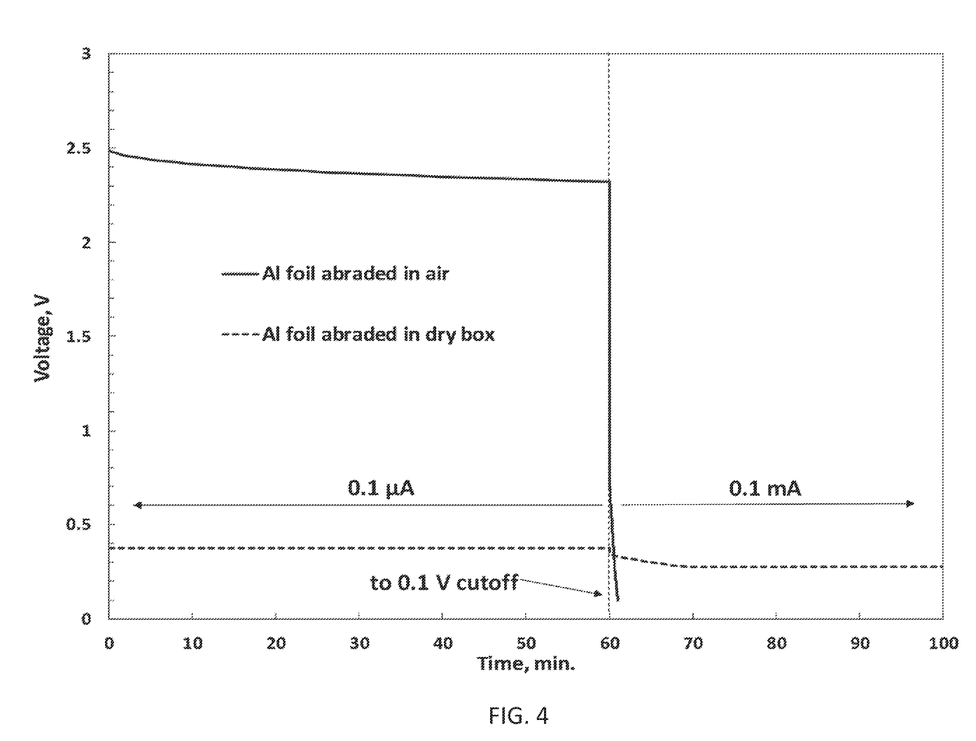

Size 2025 Li/Al coin cells were built with 127 μm thick Li foil anodes, 20 μm thick Al foil cathodes, Celgard 2500 separator and were filled with 1M LiPF6 1/1/1 EC/DMC/EMC electrolyte. Cells were assembled in an Ar-atmosphere dry box, and the Al foil was abraded with 400 grit sandpaper in air prior to being taken into the dry box. The cells were discharged at ambient temperature (RT) by a protocol in which they were first discharged at 0.1 μA for 1 hour, were then discharged at 0.1 mA for 1 hour, and were then allowed to rest for 10 hours before repeating this sequence. FIG. 4 compares results for the 3^{rd} discharge sequence of one such cell made with Al foil abraded in air to results for the 3^{rd} discharge of an Example 2 cell made with Al foil abraded in the Ar-atmosphere dry box. The cell with an Al foil cathode abraded in air had voltage above 2 V at low current of 0.1 μA but could not sustain high current of 0.1 mA at all, consistent with it having a passivating oxide coating that was only electrochemically active at extremely low current density, whereas the Example 2 cell Al cathode surface sustained voltage between 0.4 V and 0.2 V at both currents, showing that it was highly active for electrochemical alloying with Li. This result indicates that when Al electrodes were buffed in ambient atmosphere, their freshly exposed Al metal surfaces were rapidly if not immediately reoxidized by the ambient atmosphere.

### Example 5—Aluminum Foil Cathode Coated with Boron Powder/Polymer and Calendered in Air

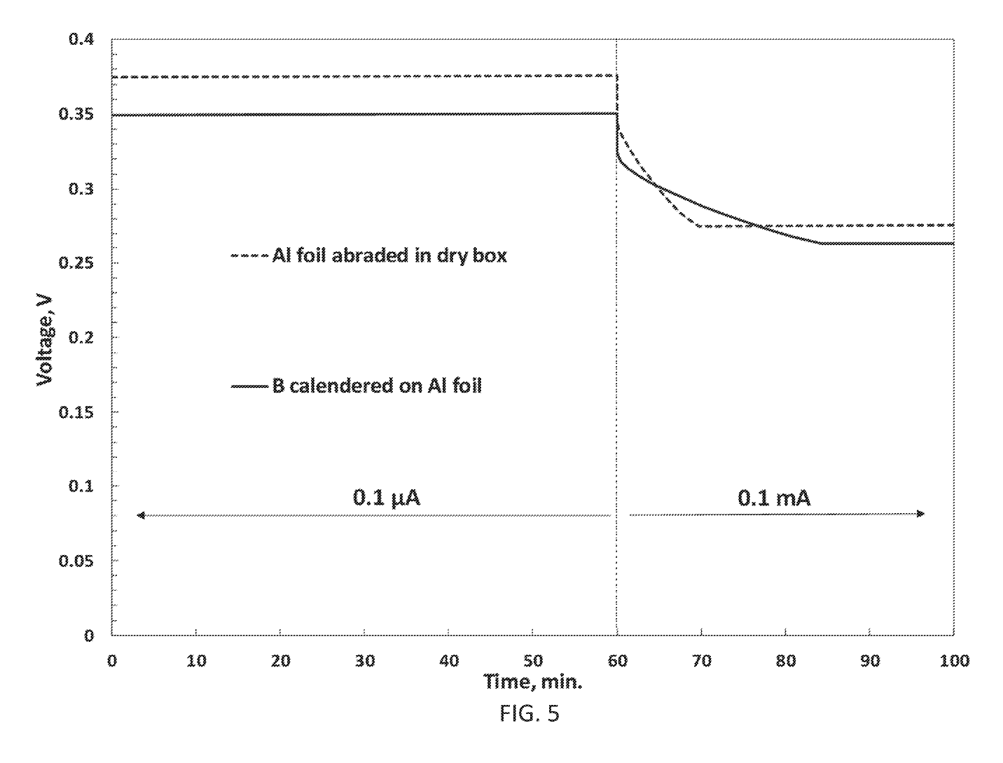

Size 2025 Li/Al coin cells were built with 127 μm thick Li foil anodes, 20 μm thick Al foil cathode coated with a submicron boron powder/acetylene black/XG Science M25 graphene/Poly(vinylidene fluoride) 60/5/15/20 by weight, Celgard 2500 separator and were filled with 1M LiPF6 1/1/1 EC/DMC/EMC electrolyte. The cathode was calendered twice in air to a coating density of 0.95 g/cc. The cathode coating weight was 2 mg/cm². Cells were assembled in an Ar-atmosphere dry box, and the Al foil was used as received. The cells were discharged at ambient temperature (RT) by a protocol in which they were first discharged at 0.1 μA for 1 hour, were then discharged at 0.1 mA for 1 hour, and were then allowed to rest for 10 hours before repeating this sequence. FIG. 5 compares results for the 7^{th} discharge sequence of one such cell made with Al foil abraded in air to results for the 3^{rd} discharge of an Example 2 cell made with Al foil abraded in the Ar-atmosphere dry box. The cell with an Al foil cathode coated with boron and calendered in air sustained voltage between 0.4 V and 0.2 V for discharge at low current of 0.1 μA and high current of 0.1 mA, as did the Example 2 cell, showing that calendaring the boron coated Al foil in air made it highly electrochemically active. The pressure together with the abrasive boron powder abraded the Al surface, exposing fresh Al while at the same time the coating was able to provide a sufficient barrier to prevent oxygen contact with the Al surface and subsequent Al oxidation.

### Example 6—Aluminum Powder with Binder Coated on Copper Foil and Calendered in Air

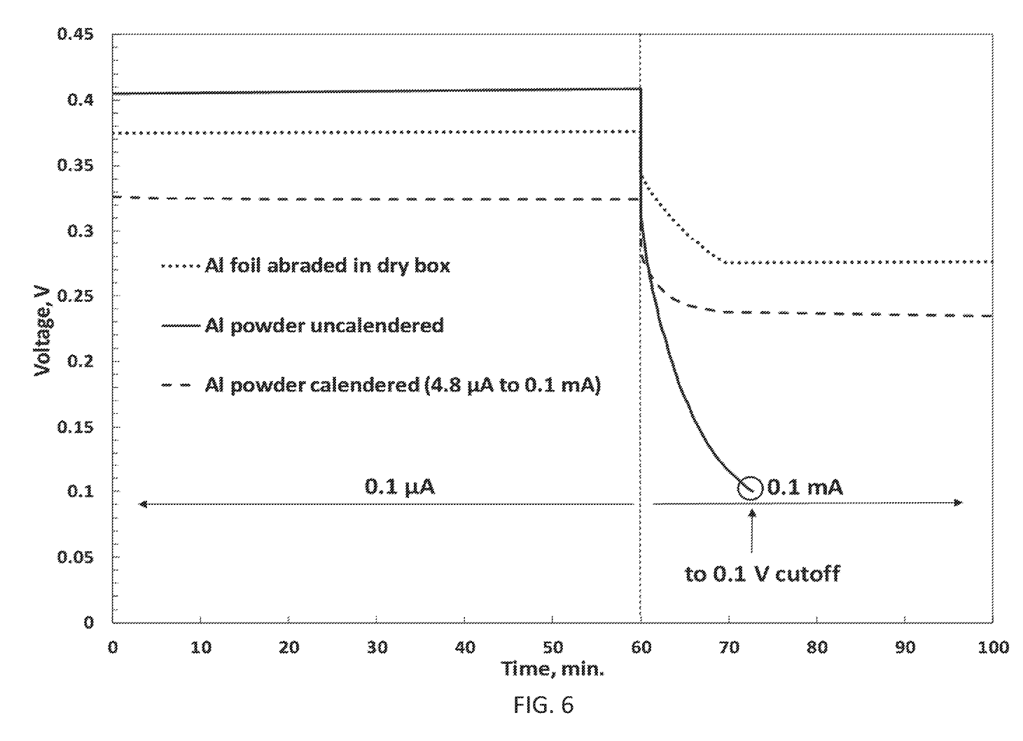

Size 2025 Li/Al coin cells were built with 127 μm thick Li foil anodes, Al powder cathodes, Celgard 2500 separator and were filled with 1M LiPF6 1/1/1 EC/DMC/EMC electrolyte. The Al cathode was composed of Al powder (17-30 micron)/acetylene black/poly(vinylidene fluoride) 80/10/10 by weight coated on 19 micron thick copper foil. One set of cells was built with no further treatment of the Al powder cathodes, and another set was built after calendering the cathodes three times in air to a coating density of 1.46 g/cc. The cathode coating weight was 1.7 mg/cm². Cells were assembled in an Ar-atmosphere dry box. The cells with uncalendered Al powder electrodes were discharged at ambient temperature (RT) by a protocol in which they were first discharged at 0.1 μA for 1 hour, were then discharged at 0.1 mA for 1 hour, and were then allowed to rest for 10 hours before repeating this sequence. The cells with calendered Al powder electrodes were discharged at ambient temperature by a protocol in which they were sequentially discharged at 1 μA, 1.73 μA, 3.70 μA, 4.8 μA and 0.1 mA, and were then allowed to rest for 2 hours before repeating this sequence. FIG. 6 compares results for the 2^{nd} discharge sequence of a cell made with a calendered Al powder cathode to the 4^{th} discharge sequence of a cell with an uncalendered Al powder cathode and to results for the 3^{rd} discharge of an Example 2 cell made with Al foil abraded in the Ar-atmosphere dry box. The cell with a calendered Al powder cathode sustained voltage between above 0.2 V for discharge at current of 0.1 mA, as did the Example 2 cell, whereas the cell with uncalendered Al powder cathode could not sustain the 0.1 mA current for longer than 15 minutes, showing that calendering the Al powder cathode increased its electrochemical activity.

### Example 7—Silicon Powder with Binder Coated on Copper Foil and Calendered in Air

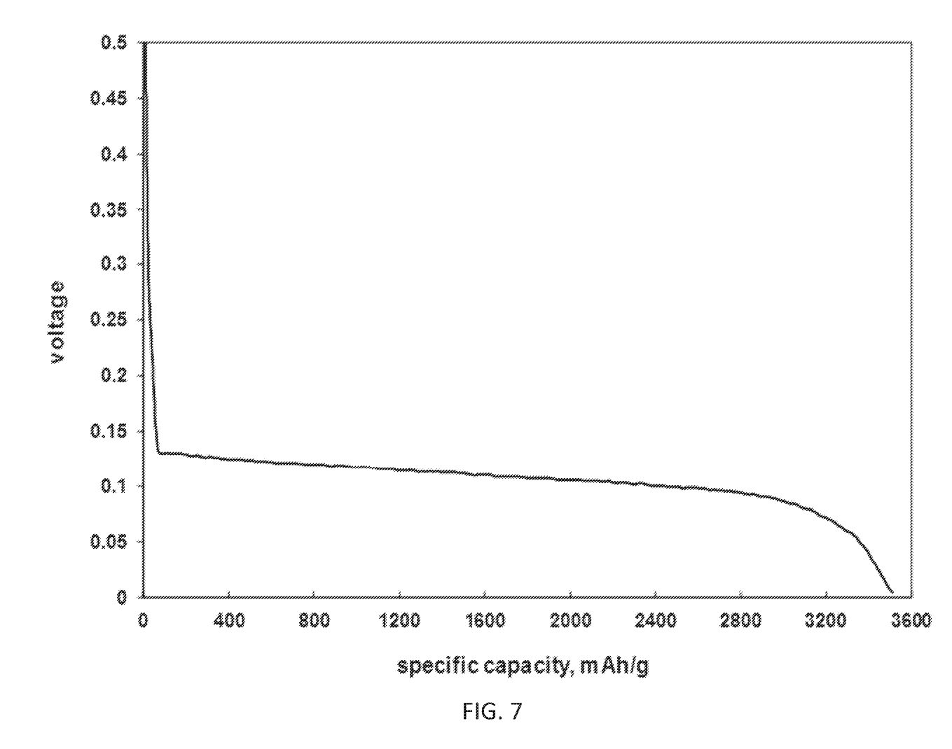

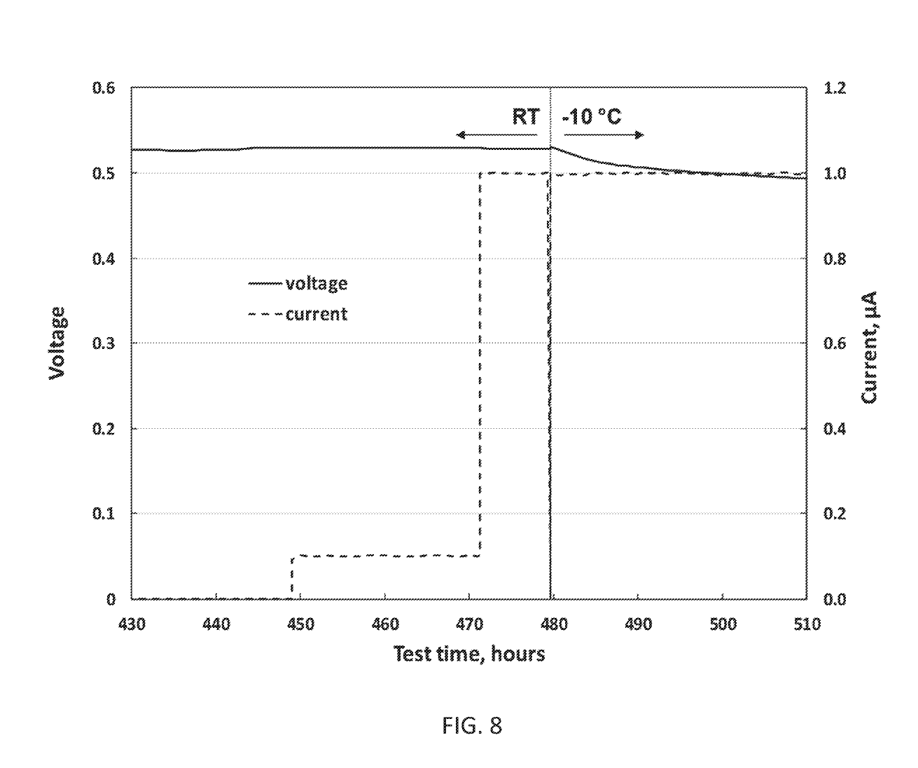

Size 2025 Li/Si coin cells were built with 127 μm thick Li foil anodes, Si powder cathodes, glass fiber separator and were filled with 1M LiPF6 1/1/1 EC/DMC/EMC electrolyte. The Si cathode was composed of Si powder (−325 mesh)/acetylene black/carboxymethylcellulose 80/12/8 by weight coated on 19 micron thick copper foil. The cathode was calendered twice in air to a coating density of 1.05 g/cc. The cathode coating weight was 2.2 mg/cm². Cells were assembled in an Ar-atmosphere dry box, and were discharged at 0.13 mA current until they reached a cutoff of 5 mV. FIG. 7 shows the voltage characteristic for complete discharge of a Li/Si cell, showing a relatively flat voltage profile at an average voltage of 0.11 V.

### Example 8—Sn-1.1% Sb Alloy Cathode

A size 2025 Li/Sn coin cell was built with a 127 μm thick Li foil anode (˜57 mAh calculated capacity), a 25 μm thick Sn (98.9 wt %)-Sb(1.1 wt %) alloy foil cathodes (˜20 mAh measured capacity) (Goodfellow Corp., part no: SN000231)), Celgard 2325 separator, and was filled with 1M LiFSI, 1/1 EC/EMC electrolyte. The cell was assembled in an Ar-atmosphere dry box, and the Sn—Sb foil was used as received. The cell was pre-discharged by 3.9 mAh at various currents of up to 100 μA, and was then allowed to rest at open circuit for about 10 hours until the voltage recovered to 0.53 V. The cell was then discharged at 100 nA and 1 μA currents at room temperature, and at 1 μA current at −10° C. FIG. 8 shows the results for these low-current discharges. Between about 430 and 450 hours of test time, the cell was at open circuit with voltage reaching a value of 0.529 V. This same voltage was maintained when the cell underwent discharge at 100 nA current at room temperature between about 450 and 470 hours, and then declined to 0.528 V when the discharge current was increased to 1 μA at room temperature between about 470 and 480 hours. At about 480 hours, the discharge was interrupted, and the cell was placed in a through-wired −10° C. freezer, where 1 μA discharge of the cell was resumed. During 30 hours of 1 μA discharge at −10° C., the cell voltage dropped to 0.494 V, a value that was 93.4% of the open circuit voltage. This example shows that the Sb alloy system when implemented with thicker foils will meet the requirement of <10% variation in voltage in a cell that delivers >100 mAh/cc.

### Example 9—Ga/Cu Alloy on Copper Foil

A size 2025 Li/Ga—Cu coin cell was built with a 127 μm thick Li foil anode (˜57 mAh theoretical capacity), a Ga/Cu foil cathode, Celgard 2325 separator, and was filled with 1M LiFSI, 1/1 wt %/wt % EC/EMC electrolyte. The cell was assembled in an Ar-atmosphere dry box. The cathode was prepared by washing a 19 micron thick copper foil with acetone followed by ultrasonicating the foil with 1M HCl for 30 seconds followed by standing in 1M HCl for 3 minutes, finally washing with distilled water and air drying. The clean dry copper foil is then rubbed onto a warm (30-40° C.) glass plate with molten gallium metal between the foil and glass plate until a smooth even coating of gallium is formed on the copper foil. The Ga coated Cu foil is then heated at 170° C. for 24 hrs under argon atmosphere resulting in a solid Ga/Cu alloy fused to Cu foil. The cathode had a Ga content of 2.5 mg/cm². The cell was discharged at 50 μA at room temperature and had a stable voltage of 0.50-0.52 V. This example shows that the Li/Sn system when implemented with thicker foils will meet the requirement of <10% variation in voltage in a cell that delivers >100 mAh/cc. This example shows that the Ga/Cu system when implemented with thicker foils will meet the requirement of <10% variation in voltage in a cell that delivers >100 mAh/cc.

### Example 10—Ga/In/Cu Alloy on Copper Foil Cathode

A size 2025 Li/Ga—In—Cu coin cell was built with a 127 μm thick Li foil anode (˜57 mAh theoretical capacity), a Ga/In/Cu foil cathode, Celgard 2325 separator, and was filled with 1M LiFSI, 1/1 EC/EMC electrolyte. The cell was assembled in an Ar-atmosphere dry box. The cathode was prepared by washing a 19 micron thick copper foil with acetone followed by ultrasonicating the foil with 1M HCl for 30 seconds followed by standing in 1M HCl for 3 minutes, finally washing with distilled water and air drying. The clean dry copper foil is then rubbed onto a warm (30-40° C.) glass plate with molten Gallium/Indium alloy (40/60 w/w Alfa Aesar 44240) between the foil and glass plate until a smooth even coating of Gallium/Indium is formed on the copper foil. The Ga/In coated Cu foil is then heated at 170° C. for 24 hrs under argon atmosphere resulting in a solid Ga/In/Cu alloy fused to Cu foil. The cathode had a Ga/In (40/60 w/w) content of 2.5 mg/cm². The cell was discharged at 50 μA at room temperature and had a stable voltage of 1.2-1.3 V. This example shows that the Ga/In/Cu system when implemented with thicker foils will meet the requirement of <10% variation in voltage in a cell that delivers >100 mAh/cc.

### Example 11—Ga/Sn/Cu Alloy on Copper Foil

A size 2025 Li/Ga—Sn coin cell was built with a 127 μm thick Li foil anode (˜57 mAh theoretical capacity), a Ga/Sn/Cu foil cathode, Celgard 2325 separator, and was filled with 1M LiFSI, 1/1 EC/EMC electrolyte. The cell was assembled in an Ar-atmosphere dry box. The cathode was prepared by washing a 19 micron thick copper foil with acetone followed by ultrasonicating the foil with 1M HCl for 30 seconds followed by standing in 1M HCl for 3 minutes, finally washing with distilled water and air drying. The clean dry copper foil is then rubbed onto a warm (30-40° C.) glass plate with molten Gallium/Tin alloy (92/8 w/w Alfa Aesar 18161) between the foil and glass plate until a smooth even coating of Gallium/Tin is formed on the copper foil. The Ga/Sn coated Cu foil is then heated at 170° C. for 20 hrs under argon atmosphere resulting in a solid Ga/Sn/Cu alloy fused to Cu foil. The cathode had a Ga/Sn(92/8 w/w) content of 5.5 mg/cm². The cell was discharged at 50 μA at room temperature and had a stable voltage of 0.5 V. This example shows that the Ga/Sn/Cu system when implemented with thicker foils will meet the requirement of <10% variation in voltage in a cell that delivers >100 mAh/cc.

### Example 12—Sb Composite Cathode

A size 2025 Li/Sb composite coin cell was built with a 127 μm thick Li foil anode (˜57 mAh theoretical capacity), Sb composite cathode, Celgard 2325 separator, and was filled with 1M LiFSI, 1/1 EC/EMC electrolyte. The cell was assembled in an Ar-atmosphere dry box. The Sb powder composite cathode was comprised of 90:5:5 w/w/w Sb(Alfa Aesar 10099—200 mesh):acetylene black:PVDF binder coated on Cu foil and calandered at 100 psi twice. The cathode had a Sb content of 2.9 mg/cm² and a density of 1.92 g/cc. The cell was discharged at 50 μA at room temperature and had a stable voltage of 0.82-0.83 V. This example shows that the Sb system when implemented with thicker foils will meet the requirement of <10% variation in voltage in a cell that delivers >100 mAh/cc.

### Example 13—Pb Cathode

A size 2025 Li/Pb coin cell was built with a 127 μm thick Li foil anode (˜57 mAh theoretical capacity), a Pb foil cathode, Celgard 2325 separator, and was filled with 1M LiFSI, 1/1 EC/EMC electrolyte. The cell was assembled in an Ar-atmosphere dry box. The Pb cathode was 100 μm thick. The cell was discharged at 50 μA at room temperature and had a stable voltage of 0.5-0.55 V. This example shows that the Sb system when implemented with thicker foils will meet the requirement of <10% variation in voltage in a cell that delivers >100 mAh/cc.

### Example 14—In Cathode

A size 2025 Li/In coin cell was built with a 127 μm thick Li foil anode (˜57 mAh theoretical capacity), a In foil cathode, Celgard 2325 separator, and was filled with 1M LiFSI, 1/1 EC/EMC electrolyte. The cell was assembled in an Ar-atmosphere dry box. The In cathode was 50 μm thick. The cell was discharged at 50 μA at room temperature and had a stable voltage of 1.35-1.4 V. This example shows that the In system when implemented with thicker foils will meet the requirement of <10% variation in voltage in a cell that delivers >100 mAh/cc.

### Example 15—Al Powder Cathode Electrochemically Activated

A size 2025 Li/Al powder composite coin cell was built with a 127 μm thick Li foil anode (˜57 mAh theoretical capacity), an Al powder composite cathode, Celgard 2325 separator, and was filled with 1M LiTFSI, 1/1 EC/EMC electrolyte. The 17-30 μm Al powder composite cathode was comprised of 90:5:5 w/w/w Al (Alfa Aesar 10576):acetylene black:PVDF binder coated on Cu foil and calendered at 20 psi twice. The cathodes had an Al coating weight of 3.5 mg/cm² and a density of 1.6 g/cc. The cell was assembled in an Ar-atmosphere. The cells were Al activated by 1.0 μA constant current charging for 1 hour whereupon the cell voltage reached 3.3 V. The cell was subsequently discharged at 1 μA at room temperature and had a stable voltage of 0.33 V. This example shows that the Al system when implemented with thicker foils will meet the requirement of <10% variation in voltage in a cell that delivers >100 mAh/cc.

Various modifications of the present disclosure, in addition to those shown and described herein, will be apparent to those skilled in the art of the above description. Such modifications are also intended to fall within the scope of the appended claims.

It is appreciated that all materials and instruments are obtainable by sources known in the art unless otherwise specified.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

The foregoing description is illustrative of particular aspects of the invention, but is not meant to be a limitation upon the practice thereof. The following claims, including all equivalents thereof, are intended to define the scope of the invention.

We claim:

1. A primary electrochemical cell having a stable operating voltage of 0.3 V to 2.0 V and comprising:
an anode comprising Li, optionally metallic lithium, lithiated carbon, lithium-aluminum alloys, lithium-tin alloys, or lithiated silicon;
a cathode comprising a Group 4A, 3A, or 5A element;
a non-aqueous electrolyte; and
optionally a lithium-ion conductive and electrically insulating separator inserted between the anode and the cathode.

2. The electrochemical cell of claim 1 wherein the cathode comprises a Group 4A, element or an alloy of a group 4A element.

3. The electrochemical cell of claim 1 wherein the cathode comprises tin, aluminum, indium, lead, zinc, antimony, cadmium, bronze, brass, tin-bismuth alloy, tin-antimony alloy, tin-copper alloy, tin-nickel alloy, gallium-copper alloy, gallium-indium-copper alloy, or tin-lead alloy.

4. The electrochemical cell of claim 1 wherein the cathode comprises tin, aluminum, gallium, antimony, or an alloy comprising tin, aluminum, gallium, antimony, copper or combinations thereof.

5. The electrochemical cell of any one of claims 1-4 wherein the electrochemical cell has a stable operating voltage of 0.3 V to 1.5 V.

6. The electrochemical cell of any one of claims 1-4 wherein the electrochemical cell has a stable operating voltage from 0.3 V to 1.0 V.

7. The electrochemical cell of any one of claims 1-4 wherein the cathode comprises an alloy of tin and antimony, the antimony present in the alloy at 0.1 to 88 atomic percent, optionally 1 to 3 atomic percent.

8. The electrochemical cell of any one of claims 1-4 wherein the lithium anode comprises lithium metal foil, the electrochemical cell optionally further comprising a tin-antimony alloy cathode.

9. The electrochemical cell of any one of claims 1-4 wherein the lithium anode is a lithium composite comprising lithium powder and a binder coated onto a copper foil substrate.

10. The electrochemical cell of claim 9 wherein the binder is a polymer.

11. The electrochemical cell of claim 9 wherein the binder comprises polybutadiene-styrene, polyisobutylene, polyisoprene or ethylene-propylene diene.

12. The electrochemical cell of any one of claims 1-4 wherein the cathode comprises a cathode metal foil comprising the Group 4A, 3A or 5A element.

13. The electrochemical cell of claim 12 wherein the cathode metal foil comprises aluminum.

14. The electrochemical cell of claim 12 wherein the cathode metal foil comprises tin.

15. The electrochemical cell of claim 12 wherein the cathode metal foil comprises an alloy of tin and antimony, the antimony present in the alloy at 0.1 to 88 atomic percent, optionally 1 to 3 atomic percent.

16. The electrochemical cell of claim 12 wherein the cathode metal foil thickness is greater than 1 micron, optionally greater than 25 microns and less than 1000 microns.

17. The electrochemical cell of claim 12 wherein the metal foil is substantially free of native surface oxide.

18. The electrochemical cell of claim 12 wherein the metal foil is coated with an abrasive powder and a polymer, and then calendered in air.

19. The electrochemical cell of claim 18 wherein the calender pressure is greater than 10 psi, optionally greater than 50 psi, optionally greater than 100 psi.

20. The electrochemical cell of claim 12 wherein the metal foil is coated with an abrasive powder, optionally acetylene black, optionally graphene, and optionally a polymer, and then calendered in air.

21. The electrochemical cell of claim 20 wherein the abrasive powder and the acetylene black are present at 50 to 95 weight percent.

22. The electrochemical cell of claim 20 wherein the abrasive powder comprises submicron boron and the polymer is polyvinylidene fluoride.

23. The electrochemical cell of claim 1 wherein cathode is a composite comprising a Group 4A, 3A, or 5A metal, a polymeric binder and a conductive additive coated onto a copper foil substrate and then calendered in air.

24. The electrochemical cell of claim 23 wherein the calender pressure is greater than 10 psi, optionally greater than 50 psi, optionally greater than 100 psi.

25. The electrochemical cell of claim 12 wherein cathode comprises indium, lead, zinc, antimony, brass, bronze, cadmium, silicon, carbon, germanium, aluminum, tin-bismuth, tin-antimony, tin-copper alloy, tin-nickel, tin-lead, tin silicon-tin, germanium-tin, niobium-tin, tin-silver-copper, or other alloy comprising these elements such as white metal or babbitt alloys, and mixtures thereof.

26. The electrochemical cell of claim 20 wherein the polymeric binder comprises polyvinylidene fluoride, polybutadiene-styrene, polyisobutylene, polyisoprene, ethylene-propylene diene, or polyacrylic acid.

27. The electrochemical cell of claim 23 wherein the conductive additive is acetylene black, graphite, graphene, and mixtures thereof.

28. The electrochemical cell of any one of claims 1-4 wherein the non-aqueous electrolyte has a vapor pressure of less than 5 mm Hg at standard temperature and pressure, optionally less than 0.2 mm Hg at standard temperature and pressure.

29. The electrochemical cell of any one of claims 1-4 wherein the non-aqueous electrolyte comprises a lithium salt and an organic solvent.

30. The electrochemical cell of claim 29 wherein the lithium salt comprises lithium hexafluorophosphate, lithium bistrifluoromethanesulfonimide, lithium triflate, lithium tetrafluoroborate, lithium iodide, and mixtures thereof.

31. The electrochemical cell of claim 29 wherein the organic solvent is a polar aprotic liquid.

32. The electrochemical cell of claim 31 wherein the organic solvent comprises a carbonate, an ether, a fluoro-substituted carbonate, a fluoroalkyl-substituted carbonate, a hydrofluoro ether, or a fluoroalkyl substituted ether and mixtures thereof.

33. The electrochemical cell of claim 32 wherein the carbonate comprises ethylene carbonate, propylene carbonate, butylene carbonate, dimethyl carbonate, ethyl-methyl carbonate, or diethylcarbonate, and mixtures thereof.

34. The electrochemical cell of claim 32 wherein the ether comprises diethylether, dimethoxyethane, bis(2-methoxyethyl) ether, diethylene glycol dimethyl ether, triethylene glycol dimethyl ether, tetraethylene glycol dimethyl ether, 1,2-dioxolane, and mixtures thereof.

35. The electrochemical cell of claim 32 wherein the fluoro-substituted carbonate comprises monofluoroethylene carbonate, difluoroethylene carbonate, or mixtures thereof.

36. The electrochemical cell of claim 32 wherein the fluoroalkyl-substituted carbonate comprises methyl 2,2,2 trifluoroethyl carbonate, ethyl 2,2,2 trifluoroethyl carbonate, or mixtures thereof.

37. The electrochemical cell of claim 32 wherein the hydrofluoro ether comprises 2-trifluoromethyl-3-methoxyperfluoropentane, 2-trifluoro-2-fluoro-3-difluoropropoxy-3-difluoro-4-fluoro-5-trifluoropentane, or mixtures thereof.

38. The electrochemical cell of any one of claims 1-4 wherein the non-aqueous electrolyte comprises an ionic liquid and a lithium salt, the ionic liquid comprising an ionic liquid cation and an ionic liquid anion.

39. The electrochemical cell of claim 38 wherein the ionic liquid cation comprises a imidazolium, alkysubstituted imidazolium, ammonium, pyridinium, pyrrolidinium, phosphonium, sulfonium moiety, or mixtures thereof.

40. The electrochemical cell of claim 38 wherein the ionic liquid anion comprises a hexafluorophosphate, bistrifluoromethanesulfonamide, triflate, tetrafluoroborate, dicyanamide, iodide moiety, or mixtures thereof.

41. The electrochemical cell of claim 38 wherein the ionic liquid is 1-ethyl-3-methylimidazolium bis (trifluoromethylsulfonyl)imide, 1-ethyl-3-methylimidazolium trifluoromethanesulfonate, 1-butyl-1-methylpyrrolidinium bis (trifluoromethylsulfonyl)imide, 1-hexyl-3-methylimidazolium hexafluorophosphate, 1-ethyl-3-methylimidazolium dicyanamide, 11-methyl-3-octylimidazolium tetrafluoroborate, or mixtures thereof.

42. The electrochemical cell of claim 38 wherein the lithium salt comprises lithium hexafluorophosphate, lithium bistrifluoromethanesulfonamide, lithium triflate, lithium tetrafluoroborate, lithium iodide, or mixtures thereof.

43. The electrochemical cell of claim 38 wherein the lithium salt concentration is 0.1 to 20% by weight.

44. The electrochemical cell of any one of claims 1-4 wherein the non-aqueous electrolyte and lithium-ion conductive and electrically insulating separator/electrolyte combination comprises a solid polymer electrolyte.

45. The electrochemical cell of claim 44 wherein the solid polymer electrolyte comprises poly(ethylene oxide) complexed with a lithium salt.

46. The electrochemical cell of claim 44 wherein the lithium salt comprises lithium hexafluorophosphate, lithium bistrifluoromethanesulfonamide, lithium triflate, lithium tetrafluoroborate, lithium iodide, or mixtures thereof.

47. The electrochemical cell of claim 44 wherein the solid polymer electrolyte comprises a plasticizing additive.

48. The electrochemical cell of claim 47 wherein the plasticizing additive has a 1 bar boiling point greater than 130° C.

49. The electrochemical cell of claim 47 wherein the plasticizing additive is present at a concentration of 0.1 to 50 percent by weight.

50. The electrochemical cell of claim 47 wherein the plasticizing additive comprises an oligomeric ether.

51. The electrochemical cell of claim 50 wherein the oligomeric ether comprises bis(2-methoxyethyl) ether, triethylene glycol dimethyl ether, tetraethylene glycol dimethyl ether, or mixtures thereof.

52. The electrochemical cell of claim 47 wherein the plasticizing additive comprises an ionic liquid comprising an ionic liquid cation and an ionic liquid anion.

53. The electrochemical cell of claim 52 wherein the ionic liquid cation comprises a imidazolium, alkysubstituted imidazolium, ammonium, pyridinium, pyrrolidinium, phosphonium, sulfonium moiety, or mixtures thereof.

54. The electrochemical cell of claim 52 wherein the ionic liquid anion comprises hexafluorophosphate, bistrifluoromethanesulfonamide, triflate, tetrafluoroborate, dicyanamide, iodide moiety, or mixtures thereof.

55. The electrochemical cell of claim 52 wherein the ionic liquid concentration is from 0.1 to 30 weight percent.

56. The electrochemical cell of any one of claims 1-4 wherein the lithium-ion conductive and electrically insulating separator is a microporous or non-woven polymer or glass fiber separator.

57. The electrochemical cell of claim 56 wherein the polymer comprises polyolefin, cellulose, mixed cellulose ester, nylon, cellophane, polyvinylidene fluoride, or glass fiber.

58. An electrochemical battery comprising two or more bipolar cells electrically connected in series wherein each bipolar cell comprises the electrochemical cell of any one of claims 1-4.

59. The battery of claim 58 wherein the non-aqueous electrolyte is a gelled electrolyte.

60. The battery of claim 58 wherein the non-aqueous electrolyte is a solid polymer electrolyte.

61. The battery of claim 58 wherein the gelled electrolyte comprises a lithium salt, an organic solvent and a polymer that is soluble in the solvent.

62. The battery of claim 58 wherein the gelled electrolyte has a yield stress of at least 5 Pa.

63. The battery of claim 60 wherein the concentration of polymer is 0.1 to 50% by weight.

64. The battery of claim 60 wherein the polymer is an organic solid.

65. The battery of claim 60 wherein the polymer is polar.

66. The battery of claim 60 wherein the polymer comprises poly(ethylene oxide), polyacrylate, polyvinylidene fluoride, poly(vinylidene fluoride-co-hexafluoropropylene) polyacrylonitrile, polystyrene-co-acrylonitrile, polyacrylamide, polyvinylacetate, polyurethane or mixtures thereof.

67. The battery of claim 59 wherein the gelled electrolyte comprises an ionic liquid, a lithium salt and a polymer that is soluble in the ionic liquid.

68. The battery of claim 67 wherein the concentration of polymer is 0.1 to 30% by weight.

69. The battery of claim 67 wherein the ionic liquid comprises a cation of a imidazolium, alkysubstituted imidazolium, ammonium, pyridinium, pyrrolidinium, phosphonium, sulfonium moiety, or mixtures thereof.

70. The gelled electrolyte of claim 67 wherein the ionic liquid comprises an anion comprising hexafluorophosphate, bistrifluoromethanesulfonamide, triflate, tetrafluoroborate, dicyanamide, iodide, or mixtures thereof.

71. The battery of claim 60 wherein the yield stress point of the solid polymer is greater than 5 Pa.

72. The battery of claim 60 wherein the polymer is an organic polar solid.

73. The battery of claim 60 wherein the solid polymer electrolyte comprises poly(ethylene oxide) complexed with a lithium salt.

74. The battery of claim 73 wherein the lithium salt comprises lithium hexafluorophosphate, lithium bistrifluoromethanesulfonamide, lithium triflate, lithium tetrafluoroborate, lithium iodide, or mixtures thereof.

75. The battery of claim 60 wherein the electrolyte is a solid polymer electrolyte comprising a plasticizing additive.

76. The battery of claim 75 wherein the plasticizing additive is present at a concentration of 0.1 to 50 weight percent.

77. The battery of claim 75 wherein the plasticizing additive has a 1 bar boiling point greater than 130° C.

78. The battery of claim 75 wherein the plasticizing additive comprises an oligomeric ether.

79. The battery of claim 78 the oligomeric ether comprises bis(2-methoxyethyl) ether, triethylene glycol dimethyl ether, tetraethylene glycol dimethyl ether, or mixtures thereof.

80. The battery of claim 75 wherein the plasticizing additive comprises an ionic liquid comprising a cation and an anion.

81. The battery of claim 80 wherein the ionic liquid concentration ranges from 1 to 30 weight percent.

82. The battery of claim 80 wherein the cation comprises a imidazolium, alkysubstituted imidazolium, ammonium, pyridinium, pyrrolidinium, phosphonium, sulfonium moiety, and mixtures thereof.

83. The battery of claim 80 wherein the anion comprises hexafluorophosphate, bistrifluoromethanesulfonamide, triflate, tetrafluoroborate, dicyanamide, iodide moiety, or mixtures thereof.

84. A wireless communication device comprising the electrochemical cell of any one of claims 1-4.

85. A wireless communication device comprising the electrochemical battery of claim 58.

86. A remote sensor containing the electrochemical cell of any one of claims 1-4.

87. A remote sensor containing the battery of claim 58.

88. An IoT device containing the electrochemical cell of any one of claims 1-4 or the battery of claim 58.

89. The electrochemical cell of any one of claims 1-4 for use in an electrical device requiring a stable voltage of 2 V or lower, optionally 1 V or lower, for 10 years or more.

90. The electrochemical cell of claim 89 wherein the non-aqueous electrolyte has a vapor pressure of less than 5 mm Hg at standard temperature and pressure, optionally less than 0.2 mm Hg at standard temperature and pressure.

91. The electrochemical cell of claim 89 wherein the cathode comprises an alloy of tin and antimony, the antimony present in the alloy at 0.1 to 88 atomic percent, optionally 1 to 5 atomic percent.

92. The electrochemical cell of claim 89 wherein the lithium anode comprises lithium metal foil.

93. The electrochemical cell of claim 92 wherein the metal foil is substantially free of native surface oxide.

94. The electrochemical cell of claim 92 wherein the metal foil is coated with an abrasive powder and a polymer.

95. The electrochemical cell of claim 94 wherein the metal foil is formed by calendaring in air at a calender pressure greater than 10 psi, optionally greater than 50 psi, optionally greater than 100 psi.

96. The electrochemical cell of claim 92 wherein the metal foil is coated with an abrasive powder, optionally acetylene black, optionally graphene, and optionally a polymer, and then calendered in air.

97. The electrochemical cell of claim 96 wherein the weight ratio of abrasive powder, acetylene black, graphene and polymer are about 60/5/15/20 respectively.

98. The electrochemical cell of claim 96 wherein the abrasive powder comprises submicron boron and the polymer is polyvinylidene fluoride.

99. A process of powering an electrical device requiring a stable voltage of 1 V or lower for 10 years or more comprising electrically connecting the electrochemical cell of any one of claims 1-4 with an electrochemical device.

100. The process of claim 99 wherein the non-aqueous electrolyte has a vapor pressure of less than 5 mm Hg at standard temperature and pressure, optionally less than 0.2 mm Hg at standard temperature and pressure.

101. The process of claim 99 wherein the cathode comprises an alloy of tin and antimony, the antimony present in the alloy at 0.1 to 88 atomic percent, optionally 1 to 5 atomic percent.

102. The process of claim 99 wherein the lithium anode comprises lithium metal foil.

103. The process of claim 102 further comprising abrading the metal foil under oxygen free atmosphere prior to the step of electrically contacting.

104. The process of claim 102 further comprising coating the metal foil with an abrasive powder and a polymer, and then calendering the metal foil in air using a calendar pressure.

105. The process of claim 104 wherein the calender pressure is greater than 10 psi, optionally greater than 50 psi, optionally greater than 100 psi.

106. The process of claim 102 further comprising coating the metal foil with an abrasive powder, acetylene black, graphene, and a polymer and then calendaring the metal foil in air.

107. The process of claim 106 wherein the weight ratio of abrasive powder, acetylene black, graphene and polymer are about 60/5/15/20 respectively.

108. The process of claim 106 wherein the abrasive powder comprises submicron boron and the polymer is polyvinylidene fluoride.

109. The cell, battery, process or device of any proceeding claim wherein the Li anode comprises metallic lithium, lithiated carbon, lithium-aluminum alloys, lithium-tin alloys, or lithiated silicon.
